(19) United States
(12) Patent Application Publication
(10) Pub. No.: US 2020/0233113 A1
(43) Pub. Date: Jul. 23, 2020

(54) ANALYZING SECONDARY ENERGY SOURCES IN SEISMIC WHILE DRILLING

(71) Applicant: Saudi Arabian Oil Company, Dhahran (SA)

(72) Inventors: Yi Luo, Dhahran (SA); Yujin Liu, Beijing (CN); Pavel Golikov, Dhahran (SA); Emad Abdo Al-Hemyari, Dhahran (SA); Abdulaziz Mohammad Almuhaidib, Dhahran (SA)

(73) Assignee: Saudi Arabian Oil Company, Dhahran (SA)

(21) Appl. No.: 16/253,595

(22) Filed: Jan. 22, 2019

(51) Int. Cl. G01V 1/50; E21B 44/00; E21B 49/00

(52) U.S. Cl. CPC G01V 1/50; E21B 44/00; E21B 49/00; G01V 2210/324; G01V 2210/52; G01V 2210/59; G01V 2210/72

(57) ABSTRACT

A system and a computer-implemented include the following. A field dataset of seismic waves is received that is obtained by receivers during a drilling period from a drilling operation at a target well. The drilling period includes drilling and non-drilling phases. The field dataset is analyzed to determine locations of seismic waves. A reconstructed wavefield is determined by applying a passive seismic imaging condition over time and based on locations of the receivers. Using the reconstructed wavefield, a time series is computed for the seismic waves, and a time-frequency transform is applied on the time series. Sources and locations of tube waves resulting from acoustic signatures of the drill bit the drilling phases are determined. Sources and locations of the body waves caused by the tube waves are determined. A petrophysical model of the target well is updated in real-time based on the analyzing and the waves.

### BACKGROUND

The present disclosure applies to the use of secondary energy sources in seismic while drilling. For example, seismic while drilling (SWD) encompasses seismic techniques in which a drilling string is lowered in to the borehole during effective drilling, maneuvering, or while connecting drill pipes. There are two conventional SWD technologies that are typically used by the industry. The first technology is drill-bit SWD, in which seismic responses generated by the drill bit under effective drilling are recorded using surface seismic sensors. However, the sensors can suffer from ambient noise and a weak acoustic response from the drill bit. The second technology is vertical seismic profiling while drilling (VSP-WD) which records seismic signals generated by an active surface seismic source and seismic sensors on a downhole assembly. However, VSP-WD can interfere with the drilling operations.

### SUMMARY

The present disclosure describes techniques that can be used for using and analyzing secondary energy sources in seismic while drilling. In some implementations, a computer-implemented method includes the following steps. A field dataset of seismic waves is received that is obtained by receivers during a drilling period from a drilling operation at a target well. The drilling period includes drilling phases and non-drilling phases. The field dataset is analyzed to determine locations of seismic waves. A reconstructed wavefield is determined by applying a passive seismic imaging condition over time and based on locations of the receivers. Using the reconstructed wavefield, a time series is computed for the seismic waves, and a time-frequency transform is applied on the time series. Sources and locations of tube waves resulting from acoustic signatures of the drill bit the drilling phases are determined from acoustic signatures of the drill bit the drilling phases. Sources and locations of the body waves caused by the tube waves are determined from the reconstructed wavefield. A petrophysical model of the target well is updated in real-time based on the analyzing and the sources and locations of the body waves and the tube waves, where real-time is a specified period of time.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, an analysis of body waves can supplement information extracted from a weak drill bit response and can improve the robustness and accuracy of seismic while drilling (SWD) operations. Second, the analysis of the body waves can be used to evaluate the drill-string vibrations (drilling dynamics) and improve drilling parameters selection.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a block diagram showing example stages of a system for performing real-time seismic while drilling (SWD) operations, according to some implementations of the present disclosure.

FIGS. 2A and 2B are maps showing example locations of an acquisition geometry of receivers and a well location, according to some implementations of the present disclosure.

FIG. 3 is a graph plotting pre-processed passive seismic data recorded for over time, according to some implementations of the present disclosure.

FIGS. 4A-4C are graphs of example reconstructed wavefields separated by time, according to some implementations of the present disclosure.

FIG. 5A is a three-dimensional image showing sources and a location of the drill bit, according to some implementations of the present disclosure.

FIG. 5B is a graph of an example of a stacking velocity curve, according to some implementations of the present disclosure.

FIG. 6 is a graph showing an example of a time-frequency analysis of seismic logging curve, according to some implementations of the present disclosure.

FIG. 7 is a flowchart of an example method for updating a petrophysical model of the target well in real-time based on analyzing the sources and locations of the body waves and the tube waves, according to some implementations of the present disclosure.

FIG. 8 is a block diagram illustrating an example computer system used to provide computational functionalities associated with described algorithms, methods, functions, processes, flows, and procedures as described in the instant disclosure, according to some implementations of the present disclosure.

Like reference numbers and designations in the various drawings indicate like elements.

### DETAILED DESCRIPTION

The following detailed description describes techniques for using and analyzing secondary energy sources in seismic while drilling, for example in oil wells and gas wells. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

In some implementations, drilling operations can use body waves that are provoked by the tube wave in the wellbore, where the tube waves originate from the movement of drill strings. Passive seismic imaging techniques can be used to reveal this type of body wave from the low signal-to-noise (S/N) ratio field data. Applications that can use this type of body wave include seismic logging while drilling and prediction formation ahead of the drill-bit.

Seismic while drilling (SWD) operations can include seismic techniques that are operated while the drill string is lowered in the borehole, during effective drilling, during maneuvers, or while connecting drill pipes. Two major SWD technologies are often used by the industry. The first technique is drill-bit SWD, which records seismic noise generated by the drill bit under effective drilling on the surface seismic sensors. The second technique is vertical seismic profile while drilling (VSP-WD), which records seismic signals generated by a surface seismic source on seismic sensors integrated inside the downhole borehole assembly.

VSP-WD is an emerging technology but is already included in the commercial products of some service providers. The technology can decrease drilling risk and lower costs. Because VSP-WD technology uses source information on the surface and receivers inside the wellbore, the technology can slow down the drilling process, and the data gathered can be difficult to interpret in real time.

The present disclosure focuses on drill-bit SWD technology. The roller bit has historically been a good source of noise since the roller bit makes more noise while rock is being crushed. However, typical drilling operations currently use a polycrystalline diamond cutter (PDC) bit that shears the rock, which is quieter than the roller bit and not an adequate source for geophones on the surface. For this reason, other mechanics of downhole sources can be used that are generated by the movement of drill strings.

In some implementations, reconstructed wavefields can be analyzed and passive seismic imaging techniques can be used to locate sources and image formations around and ahead of the drill bit. For example, experiments can be conducted that include pre-processing and imaging of field passive seismic data to verify the mechanics of body waves, which are rarely studied. Additionally, multiple numerical tests can be conducted for different models and acquisition setups.

Seismic while drilling (SWD) techniques can be used while drilling. For example, drill-bit SWD can be used to record seismic responses generated by the drill bit under effective drilling using surface seismic sensors. In another example, vertical seismic profiling while drilling (VSP-WD) can be used to record seismic signals generated by an active surface seismic source and seismic sensors on a downhole assembly. However, these techniques have disadvantages. For example, during drill-bit SWD, the sensors can suffer from ambient noise and a weak acoustic response from the drill bit. VSP-WD can interfere with the drilling operations.

Techniques described in the present disclosure can include the use of seismic body waves originating from drilling string movements and waves originating from drilling string or wellbore density anomalies which can act as secondary sources. The techniques can be used in a passive recording setting of SWD, where recorded body waves are stronger than the drill bit acoustic signature, and where no well intervention is required (since intervention can cause drilling delays). Therefore, analysis of the body waves can supplement the information extracted from weak drill bit response and can improve the robustness and accuracy of SWD. The body waves can be generated as a result of a chain of reactions. Body waves can be provoked by tube waves, while tube waves can be stimulated by drilling string movements. The use of these waves can improve estimates of rock properties of formations being drilled in real time and can help in predicting subsurface formations ahead of the drill bit. Real seismic data can be used to demonstrate the potential applications of such waves generated by secondary sources other than the drill bit itself.

One objective of having a real-time SWD system is to provide real-time insight and information to drilling and geosteering personnel. For example, the term real-time can correspond to events that occur within a specified period of time, such as one minute, one second, or milliseconds. Geosteering personnel can use real-time information (for example, available within a few seconds or a few minutes) to make informed decisions regarding ongoing drilling programs and steering directions. During typical drilling operations, drillers generally rely on combinations of previous drilling information, ongoing drilling measurements, and drilling cuttings that are correlated to characterize formations being drilled and to generate indications regarding drilling operations. However, this type of information is typically not provided in real time to drilling operations. Delays in providing information to drillers can prevent the drillers from making prompt decisions, which can increase risks created by not having up-to-date information. The increased risks can be even more problematic, for example, when decisions need to be made that are important to the safety of the drilling staff, the safety of the drilling equipment, and the integrity of drilled wells.

In some implementations, the techniques described in the present disclosure can be part of a real-time system that has three main components or processes. For example, the three main processes can include processes for preparation, execution, and outcome.

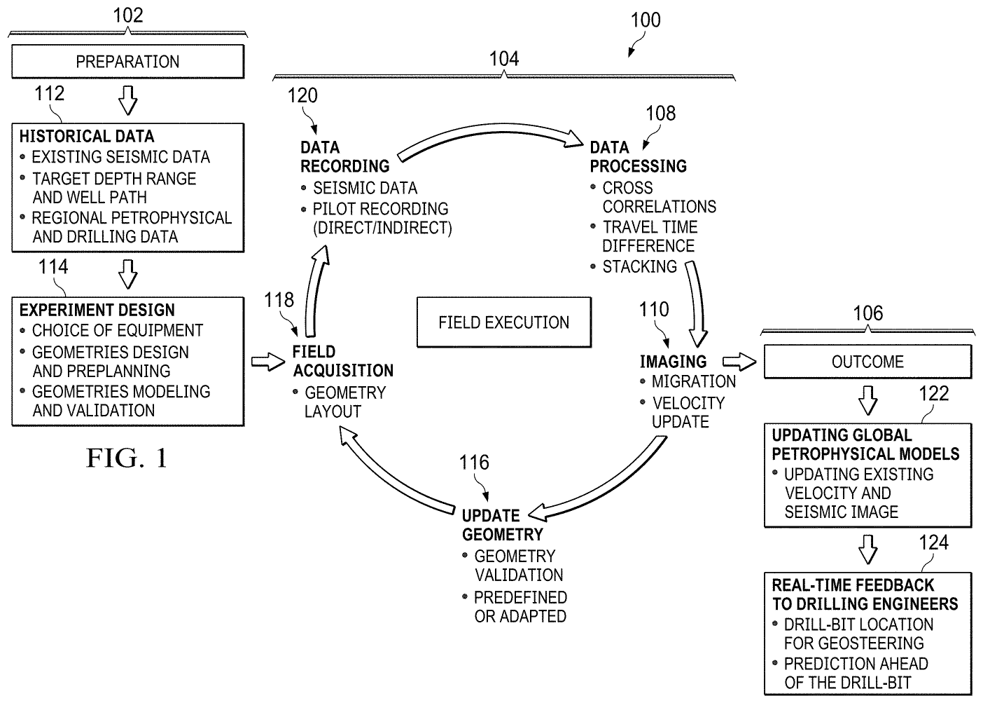

FIG. 1 is a block diagram showing example stages of a system 100 for performing real-time SWD operations, according to some implementations of the present disclosure. A preparation stage 102 can be used to prepare data for a subsequent field execution stage 104. For example, the preparation stage 102 can be used to assure the quality of collected data, which can lead to smooth execution during the field execution stage 104. The field execution stage 104 can occur in real-time in the field where data is iteratively collected, processed, and imaged while drilling operations occur. The field execution stage 104 can provide a real-time feedback loop for drilling engineers, including providing current drill-bit locations iteratively and predictions for conditions ahead of the drill-bit. The preparation stage 102 and the field execution stage 104 precede an outcome stage 106 in which outputs of the system 100 are produced.

The present disclosure focuses mostly on components of the field execution stage 104, including a data processing component 108 and an imaging component 110. The present disclosure also focuses on components of the outcome stage 106. The outcome stage 106 includes updating global petrophysical models 122, including updating existing velocity models. The outcome stage 106 also includes providing real-time feedback to drilling engineers 124, including providing images (ahead of the drill bit) to the drilling engineer. The real-time feedback can also include drill bit location information for geo-steering and prediction information ahead of the drill bit.

The preparation stage 102 can be used to prepare information in the areas of historical data 112 and experiment design 114. The historical data 112 can include existing seismic data, target depth range and well path data, and regional petrophysical and drilling data. The historical data 112 can be collected and integrated into a sub-surface model. The experiment design 114 can include, for example, choice of equipment information geometries for design and preplanning, and geometries for modeling and validation.

The field execution stage 104 can include other components in addition to the data processing component 108 and the imaging component 110. An update geometry component 116 can provide geometry validation using geometry that is pre-defined or adapted (for example, in real time). A field acquisition component 118 can provide a geometry layout that is used during drilling operations. A data recording component 120 can record seismic data and a pilot recording (direct and indirect).

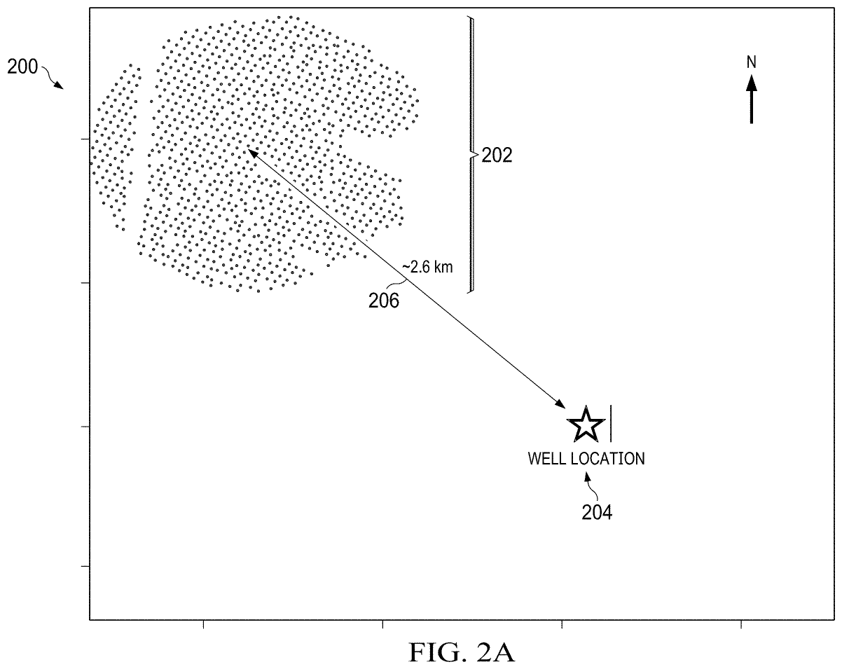

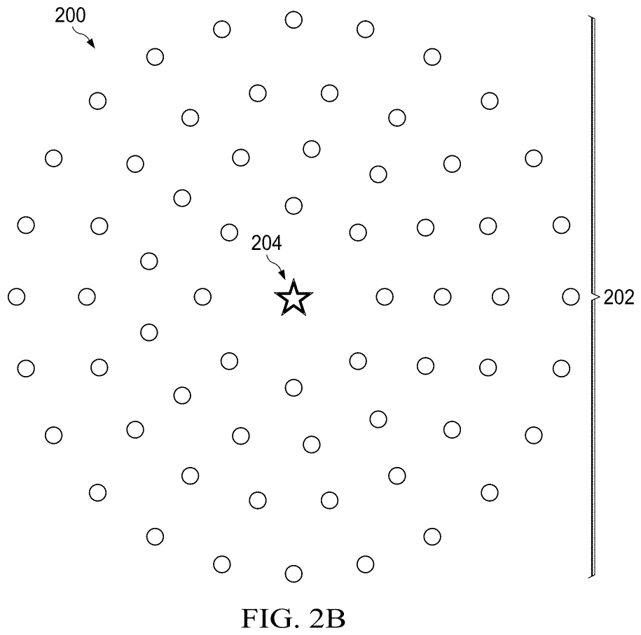

FIGS. 2A and 2B are maps 200 showing example locations of an acquisition geometry of receivers 202 and a well location 204, according to some implementations of the present disclosure. The acquisition geometry can refer to an array of geophones, for example. In the example shown in FIG. 2A, a distance 206 of approximately 2.6 kilometers (km) separates a surface location of the well location 204 from a center point of the receivers 202. The configuration of the receivers 202 resulted from an initial experiment that was conducted using an existing set of receivers and a well being drilled in the vicinity of those receivers 2.6 km away. In the example shown in FIG. 2B, the well location 204 is in a center of a circular configuration of the receivers 202. Other configurations of the receivers 202 are possible. Experimentation has shown that the configuration of the receivers 202 and the well location 204 can be used, for example, to analyze a field dataset that is acquired using 1003 geophones and spanning a period of 74 hours. The geophones can be buried underground, for example, at the depth ranging from 50 meters to 87 meters. The geophones can be distributed in a circular area with an interval of approximately 50 meters separating neighboring geophones. The recording period (for example, 74 hours) can be divided into four parts of a non-drilling phase and five parts of a drilling phase. The geophones can record the data in passive way. Some basic preprocessing can be applied, for example, pilot trace correlation, bandpass filtering, bad traces muting, and amplitude correction.

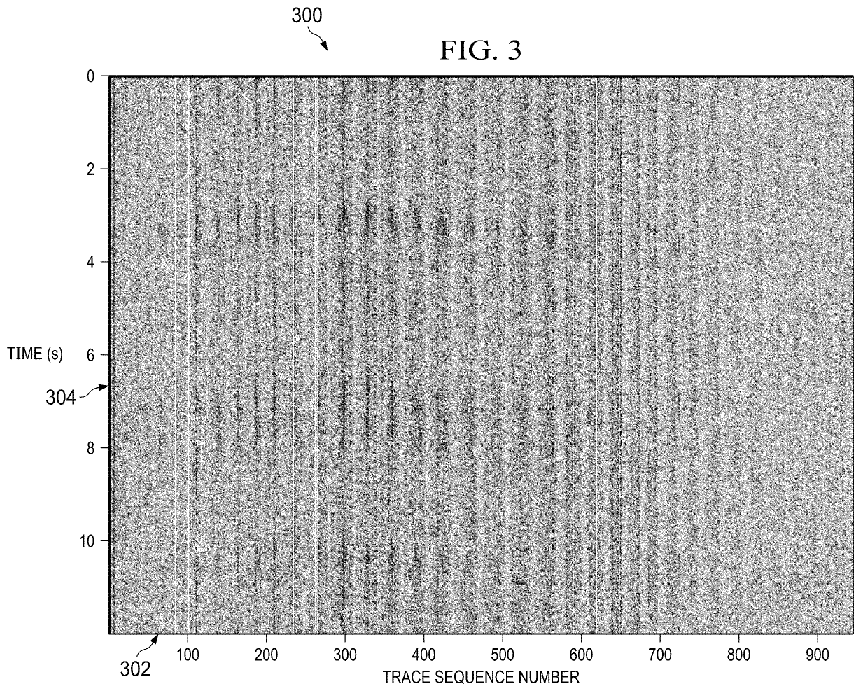

FIG. 3 is a graph 300 plotting pre-processed passive seismic data recorded for over time, according to some implementations of the present disclosure. For example, the seismic data is plotted relative to a trace sequence number axis 302 and a time axis 304 in seconds (for example, over 12 seconds).

Various techniques (including imaging techniques) can be used to locate the sources of the seismic waves recorded by the geophones. For example, the following passive seismic imaging condition can be used:

I(x)=Σₜu²(x,t) (1)

where I(x) is the source image in the 3-D space domain (for example, x∈R³), and where u(x, t) is a receiver wavefield reconstructed by the following:

u(x,t)=F⁻¹[Σₓ_{ᵣ}D(xᵣ,ω)G*(xᵣ,ω)] (2)

where D(xᵣ, ω) is the recorded data at the receiver position xᵣ after a Fourier transform F, where ω is the circular frequency, where t is a travel time, where * is a complex conjugate, and where G(xᵣ, x, ω) is a frequency-domain Green's function. The Green's function can be approximated, for example, using a finite-difference method or some other numerical method to solve the wave equation. In the current example, a ray-based method is used.

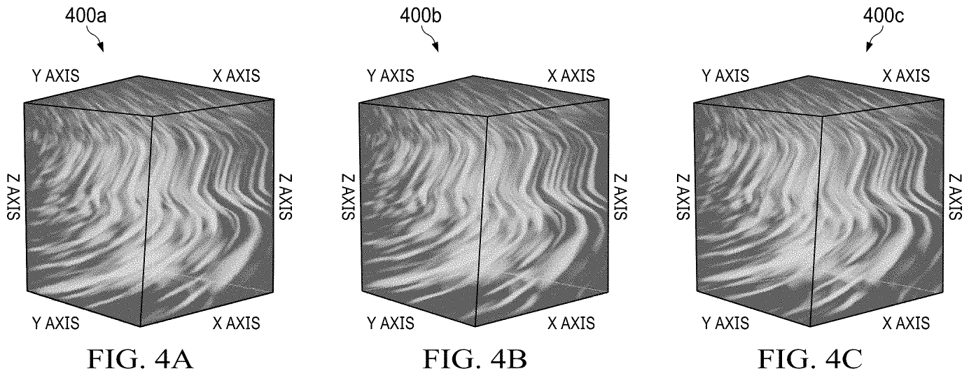

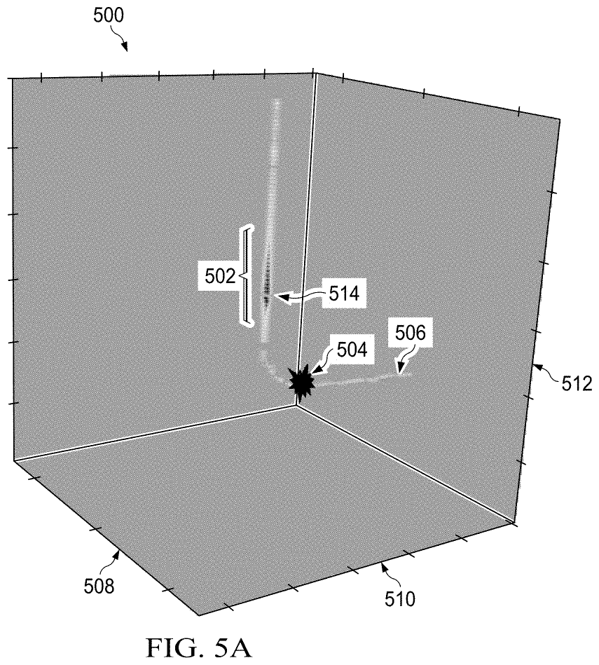

FIGS. 4A-4C are graphs of example reconstructed wavefields 400a-400c separated by time, according to some implementations of the present disclosure. For example, the wavefield 400a is a wavefield at time T seconds. The wavefield 400b is a wavefield at time T+0.04 seconds. The wavefield 400c is a wavefield at time T+0.08 seconds. The three wavefields 400a-400c can serve as snapshots from which it can be inferred that the seismic waves propagate from the wellbore to the seismic sensors on the surface.

The reconstructed wavefields 400a-400c can be used with Equation (2) to determine that observed seismic waves originate mainly from the sources located underground. After determining a source location using Equation (1), for example, it can be determined that the position of located source is more shallow than the true depth of the drill bit.

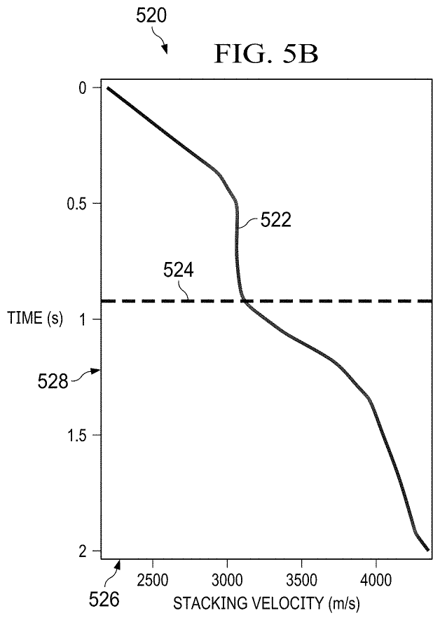

FIG. 5A is a three-dimensional image 500 showing sources and a location of the drill bit, according to some implementations of the present disclosure. For example, carmine (dark red to slight purple) dots 502 denote image of sources, a red dot 504 denotes the true location of drill bit, and green dots 506 denote the well path. The three-dimensional image 500 is presented relative to an x-coordinate 508, a y-coordinate 510, and a z-coordinate 512.

The location of the sources is consistent with locations of greatest velocity contrast. It can be inferred that received body waves come from secondary sources which are converted from tube waves in the wellbore. Wave mode conversion can occur, for example, at places where greatest velocity contrasts exist, at discontinues, and at density anomalies in casing (for example, perforations, drill string locks, or packers). On the other hand, tube waves in the wellbore can be related to the movement of drill strings, vibrations of the drill bit, and other drilling activities. These types of phenomena are consistent with configurations used in cross-well seismic exploration.

FIG. 5B is a graph 520 of an example of a stacking velocity curve 522, according to some implementations of the present disclosure. A red dashed line 524 denotes a pseudo-depth (time) position of the drill bit. The stacking velocity curve 522 is plotted relative to a stacking velocity axis 526 and a time axis 528.

Using a source location xₛ as a reference image point, a time series u(xₛ, t) can be computed, and a time-frequency transform can be applied to the time series. Comparisons with the drilling progress can result in a conclusion that the time series is consistent with the drilling log. By analyzing reconstructed wavefields, and by using source imaging and the time series at the source location, a conclusion can be made that recorded seismic noise comes from the body waves provoked by the tube waves. For example, the recorded seismic noise occurs while the tube waves are generated by drilling activities.

The initial geometry can be validated (for example, by the update geometry component 116) after each imaging step. The geometry can be updated, if necessary, to preserve an offset-to-depth ratio close to 1.0.

Referring again to the outcome stage 106, outcome stage 106 can include updating global petrophysical models 122 and using real-time feedback. The initial velocity/density model can be constantly updated using two methods: 1) a direct drill bit signal tomography (similar to checkshot survey), and a migration velocity analysis (MVA) of the correlated data.

Real-time feedback can be based on two techniques that use seismic signals in the configuration of seismic while drilling. The first technique is seismic logging while drilling. The second technique is a prediction formation ahead of drill bit.

Seismic logging while drilling techniques can be used to extract time series at the source location and predict the rock properties in real time by analyzing the correction between the time series and rock properties. For example, a seismic logging while drilling workflow can include the following. First, a moveout correction is applied to the observed data, for example, by applying a source-receiver distance dependent time shift to each trace. Second, the corrected (or time-shifted) traces can be stacked into a single trace. In this example, amplitude values of all traces at each time step can be summed together and normalized to provide one supertrace. Third, a time-frequency analysis method (such as short-time Fourier transform) can be applied to the stacked trace. Application of the time-frequency analysis method can result in decomposing the time series within each short-time window into different frequency components. Fourth, rock properties can be predicted from the time-frequency spectrum, for example, by applying machine learning techniques such as a neural network analysis. Primary components needed for predicting the propertied can include data obtained earlier in similar conditions. Fifth, information that includes the predicted knowledge of the geological formation around and ahead of the drill bit (for example, rock hardness, pore pressure, and fractures) can be used to adjust drilling programs in real time. Adjustments made to drilling programs can result in optimizations related to drilling time and costs.

Predictions of formations ahead of the drill bit can be based on reflected waves from the layers under the sources. For example, a conventional time-domain or depth-domain migration method can be applied to obtain the image of the subsurface structure. An example workflow can include the following. First, the receiver wavefield can be back-propagated, and cross-correlation imaging condition can be applied. For example, Equation (1) can be used to obtain the image of the sources without any picking process. A conventional imaging condition can be used to pick the time when the image shows the maximum amplitude in a 4D cube (representing a 3D space dimension and a time dimension). Second, location of the sources can be selected where maximum energy exists in the source image, as shown by arrow 514 in FIG. 5A. Third, the source signature can be estimated by extracting the back-propagated receiver wavefields at the source location. After reconstructing receiver wavefields within the total time period, the source signature can be extracted from the wavefields at the source location. The reconstructed wavefields 400a-400c shown in FIG. 4A-4C, for example, show three wavefield snapshots at three time steps. Fourth, a conventional seismic migration method can be applied to obtain the structure image under the source. Fifth, information about the predicted structure image ahead of the drill bit can be used to navigate drilling. For example, the drilling direction can be changed in three dimensions based on the predicted image. The image can also be used to match the surface seismic image in order to provide a higher-resolution image than can be obtained at the surface. The higher-resolution image can serve as a map that be used to guide the driller, using subsurface structures information around the drill bit in real time.

In some implementations, the conventional seismic migration method of the fourth step can include the following sub-steps. First, the source wavefield can be forward-propagated using the estimated source signature. For example, in a reverse-time migration, the source wavefield can be reconstructed from propagating forward in time, with a boundary condition of the source signature at the source location. Second, the receiver wavefield can be back-propagated, which can be restored using the first sub-step. For example, in a reverse-time migration, the receiver wavefield can be reconstructed from propagating backward in time, with a boundary condition of the recorded data on the surface. Third, a zero-lag cross-correlation imaging condition can be applied to obtain the subsurface image. For example, in a reverse-time migration, the subsurface structural image can be obtained by extracting the zero-lag result after cross-correlating the reconstructed source wavefield and receiver wavefield.

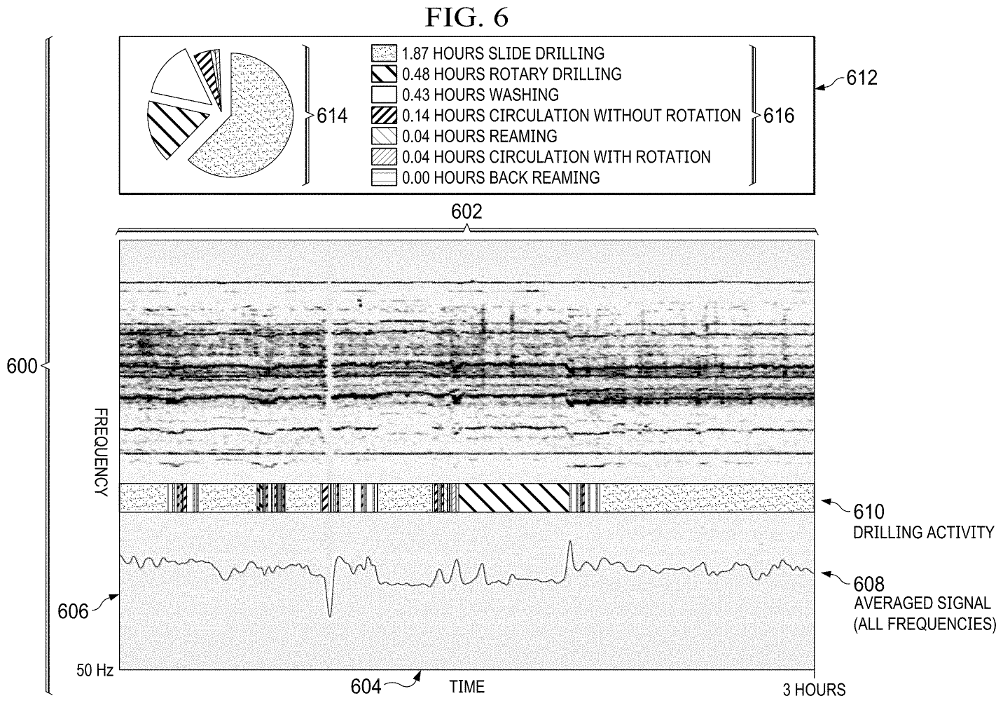

FIG. 6 is a graph 600 showing an example of a time-frequency analysis of a seismic logging curve 602, according to some implementations of the present disclosure. The seismic logging curve 602 is plotted relative to a time axis 604 (for example, spanning a time period of three hours) and a frequency axis 606 (for example, measured in Hertz (hz)). Each point in time and at a certain frequency is a measure of the amplitude of recorded seismic signal at that specific time and frequency. While various frequencies are plotted in the seismic logging curve 602, an average signal curve 608 indicates the average of the signals over the time axis 604. A drilling activity color band 610 in the seismic logging curve 602 indicates different types of activities that occurred over time. The drilling activity color band 610 includes individual colors that are identified in a color band key 612. For example, the color band key 612 includes a pie chart 614 that identifies, by color, proportional total durations of the various activities. A list of activities and associated times 616 identifies the total number of hours (or fractions of hours) by color-coded activity. The activities include, for example, slide drilling, rotary drilling, washing, circulation without rotation, reaming, circulation with rotation, and back reaming.

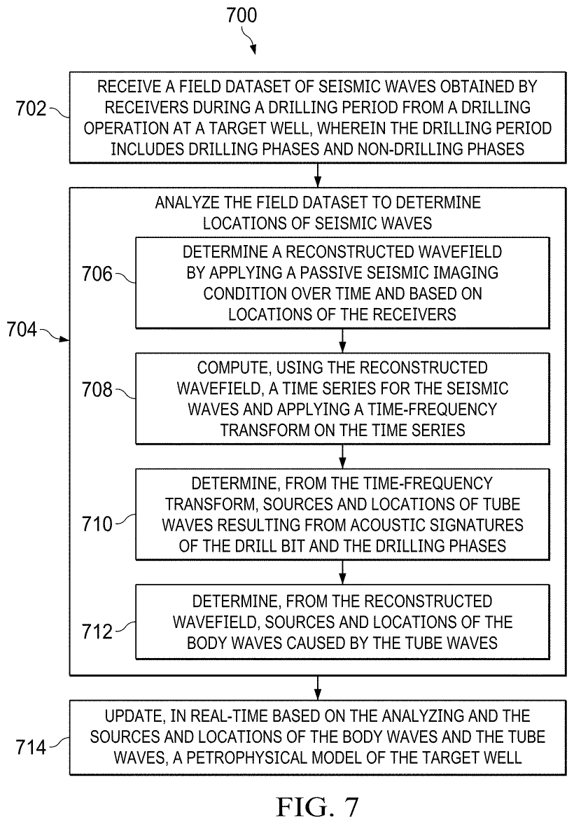

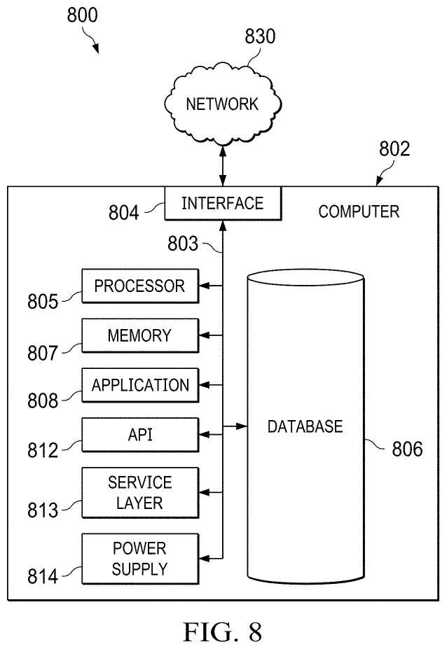

FIG. 7 is a flowchart of an example method 700 for updating a petrophysical model of the target well in real-time based on analyzing the sources and locations of the body waves and the tube waves, according to some implementations of the present disclosure. For clarity of presentation, the description that follows generally describes method 700 in the context of the other figures in this description. However, it will be understood that method 700 may be performed, for example, by any suitable system, environment, software, and hardware, or a combination of systems, environments, software, and hardware, as appropriate. In some implementations, various steps of method 700 can be run in parallel, in combination, in loops, or in any order.

At 702, a field dataset of seismic waves obtained by receivers during a drilling period is received from a drilling operation at a target well, wherein the drilling period includes drilling phases and non-drilling phases. For example, seismic waves can be collected from the receivers 202 (for example, an array of geophones) near a well location 204.

At 704, the field dataset is analyzed to determine locations of seismic waves. For example, the signals received from the geophones can be used to identify the locations of the seismic waves. In some implementations, analyzing the field dataset can include steps 706-712.

At 706, a reconstructed wavefield is determined by applying a passive seismic imaging condition over time and based on locations of the receivers. For example, a large number of time-specific wavefields can be used to construct each of the wavefields 400a, 400b, and 400c.

At 708, computing, using the reconstructed wavefield, a time series for the seismic waves and applying a time-frequency transform on the time series. For example, a large number of time-specific wavefields (in addition to the wavefields 400a, 400b, and 400c at times T seconds, T+0.04 seconds, and T+0.08 seconds) can be used to construct the reconstructed wavefield.

At 710, sources and locations of tube waves resulting from acoustic signatures of the drill bit the drilling phases are determined from the time-frequency transform. For example, using the wavefields 400a, 400b, and 400c at times T seconds, T+0.04 seconds, and T+0.08 seconds, the system 100 can determine the sources and locations of the tube waves.

At 712, sources and locations of the body waves caused by the tube waves are determined from the reconstructed wavefield. As an example, using the wavefields 400a, 400b, and 400c at times T seconds, T+0.04 seconds, and T+0.08 seconds, the system 100 can determine the sources and locations of the body waves.

At 714, a petrophysical model of the target well is updated in real-time based on the analyzing and the sources and locations of the body waves and the tube waves. The system 100 can use the tube waves and the body waves in the update geometry component 116 to validate geometry in the petrophysical model.

FIG. 8 is a block diagram of an example computer system 800 used to provide computational functionalities associated with described algorithms, methods, functions, processes, flows, and procedures, as described in the instant disclosure, according to some implementations of the present disclosure. The illustrated computer 802 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 802 may comprise a computer that includes an input device, such as a keypad, keyboard, touch screen, or other device that can accept user information, and an output device that conveys information associated with the operation of the computer 802, including digital data, visual, or audio information (or a combination of information), or a graphical-type user interface (UI) (or GUI).

The computer 802 can serve in a role as a client, network component, a server, a database or other persistency, or any other component (or a combination of roles) of a computer system for performing the subject matter described in the instant disclosure. The illustrated computer 802 is communicably coupled with a network 830. In some implementations, one or more components of the computer 802 may be configured to operate within environments, including cloud-computing-based, local, global, or other environment (or a combination of environments).

At a high level, the computer 802 is an electronic computing device operable to receive, transmit, process, store, or manage data and information associated with the described subject matter. According to some implementations, the computer 802 may also include or be communicably coupled with an application server, email server, web server, caching server, streaming data server, or other server (or a combination of servers).

The computer 802 can receive requests over network 830 from a client application (for example, executing on another computer 802) and respond to the received requests by processing the received requests using an appropriate software application(s). In addition, requests may also be sent to the computer 802 from internal users (for example, from a command console or by other appropriate access method), external or third-parties, other automated applications, as well as any other appropriate entities, individuals, systems, or computers.

Each of the components of the computer 802 can communicate using a system bus 803. In some implementations, any or all of the components of the computer 802, hardware or software (or a combination of both hardware and software), may interface with each other or the interface 804 (or a combination of both), over the system bus 803 using an application programming interface (API) 812 or a service layer 813 (or a combination of the API 812 and service layer 813). The API 812 may include specifications for routines, data structures, and object classes. The API 812 may be either computer-language independent or dependent and refer to a complete interface, a single function, or even a set of APIs. The service layer 813 provides software services to the computer 802 or other components (whether or not illustrated) that are communicably coupled to the computer 802. The functionality of the computer 802 may be accessible for all service consumers using this service layer. Software services, such as those provided by the service layer 813, provide reusable, defined functionalities through a defined interface. For example, the interface may be software written in JAVA, C++, or other suitable language providing data in extensible markup language (XML) format or other suitable format. While illustrated as an integrated component of the computer 802, alternative implementations may illustrate the API 812 or the service layer 813 as stand-alone components in relation to other components of the computer 802 or other components (whether or not illustrated) that are communicably coupled to the computer 802. Moreover, any or all parts of the API 812 or the service layer 813 may be implemented as child or sub-modules of another software module, enterprise application, or hardware module without departing from the scope of this disclosure.

The computer 802 includes an interface 804. Although illustrated as a single interface 804 in FIG. 8, two or more interfaces 804 may be used according to particular needs, desires, or particular implementations of the computer 802. The interface 804 is used by the computer 802 for communicating with other systems that are connected to the network 830 (whether illustrated or not) in a distributed environment. Generally, the interface 804 comprises logic encoded in software or hardware (or a combination of software and hardware) and is operable to communicate with the network 830. More specifically, the interface 804 may comprise software supporting one or more communication protocols associated with communications such that the network 830 or interface's hardware is operable to communicate physical signals within and outside of the illustrated computer 802.

The computer 802 includes a processor 805. Although illustrated as a single processor 805 in FIG. 8, two or more processors may be used according to particular needs, desires, or particular implementations of the computer 802. Generally, the processor 805 executes instructions and manipulates data to perform the operations of the computer 802 and any algorithms, methods, functions, processes, flows, and procedures as described in the instant disclosure.

The computer 802 also includes a database 806 that can hold data for the computer 802 or other components (or a combination of both) that can be connected to the network 830 (whether illustrated or not). For example, database 806 can be an in-memory, conventional, or other type of database storing data consistent with this disclosure. In some implementations, database 806 can be a combination of two or more different database types (for example, a hybrid in-memory and conventional database) according to particular needs, desires, or particular implementations of the computer 802 and the described functionality. Although illustrated as a single database 806 in FIG. 8, two or more databases (of the same or combination of types) can be used according to particular needs, desires, or particular implementations of the computer 802 and the described functionality. While database 806 is illustrated as an integral component of the computer 802, in alternative implementations, database 806 can be external to the computer 802.

The computer 802 also includes a memory 807 that can hold data for the computer 802 or other components (or a combination of both) that can be connected to the network 830 (whether illustrated or not). Memory 807 can store any data consistent with this disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same or combination of types) can be used according to particular needs, desires, or particular implementations of the computer 802 and the described functionality. While memory 807 is illustrated as an integral component of the computer 802, in alternative implementations, memory 807 can be external to the computer 802.

The application 808 is an algorithmic software engine providing functionality according to particular needs, desires, or particular implementations of the computer 802, particularly with respect to functionality described in this disclosure. For example, application 808 can serve as one or more components, modules, or applications. Further, although illustrated as a single application 808, the application 808 may be implemented as multiple applications 808 on the computer 802. In addition, although illustrated as integral to the computer 802, in alternative implementations, the application 808 can be external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion or management circuits (including recharging, standby, or other power management functionality). In some implementations, the power-supply 814 can include a power plug to allow the computer 802 to be plugged into a wall socket or other power source to, for example, power the computer 802 or recharge a rechargeable battery.

There may be any number of computers 802 associated with, or external to, a computer system containing computer 802, each computer 802 communicating over network 830. Further, the term “client,” “user,” and other appropriate terminology may be used interchangeably, as appropriate, without departing from the scope of this disclosure. Moreover, this disclosure contemplates that many users may use one computer 802, or that one user may use multiple computers 802.

Described implementations of the subject matter can include one or more features, alone or in combination.

For example, in a first implementation, a computer-implemented method, comprises the following. A field dataset of seismic waves is received that is obtained by receivers during a drilling period from a drilling operation at a target well. The drilling period includes drilling phases and non-drilling phases. The field dataset is analyzed to determine locations of seismic waves. A reconstructed wavefield is determined by applying a passive seismic imaging condition over time based on locations of the receivers. Using the reconstructed wavefield, a time series is computed for the seismic waves, and a time-frequency transform is applied on the time series. Sources and locations of tube waves resulting from acoustic signatures of the drill bit and the drilling phases are determined from acoustic signatures of the drill bit the drilling phases. Sources and locations of the body waves caused by the tube waves are determined from the reconstructed wavefield. A petrophysical model of the target well is updated in real-time based on the analyzing and the sources and locations of the body waves and the tube waves, where real-time is a specified period of time.

The foregoing and other described implementations can each, optionally, include one or more of the following features:

A first feature, combinable with any of the following features, the method further comprising updating seismic logging information in real-time during the drilling operation using the updated petrophysical model.

A second feature, combinable with any of the previous or following features, further comprising predicting, in real-time and using the updated petrophysical model, geophysical formations ahead of drill bit.

A third feature, combinable with any of the previous or following features, further comprising performing preprocessing on the field dataset including: processing the field dataset, the processing including pilot trace correlation, band-pass filtering, bad traces muting, and amplitude correction; and updating the field dataset based on the processing.

A fourth feature, combinable with any of the previous or following features, wherein the receivers include a geophone array of individual geophones arranged at pre-determined intervals, and wherein a center of the geophone array is located a distance away from a surface location of the target well.

A fifth feature, combinable with any of the previous or following features, wherein updating the seismic logging information during the drilling operation comprises the following. A moveout correction to traces in the seismic logging information is applied by applying a source-receiver distance dependent time shift to each trace of the seismic logging information. The traces are combined into a single trace by summing amplitude values of all traces at each time step and normalizing the traces to create a supertrace. A time-frequency analysis method is applied to the supertrace, decomposing the time series within each short-time window into different frequency components. Rock properties around and ahead of the drill bit are predicted using the time-frequency analysis and by applying machine learning techniques. The rock properties are associated with geological formations, including rock hardness, pore pressure, and fractures. A drilling program is adjusted in real time using the predicted rock properties around and ahead of the drill bit.

A sixth feature, wherein predicting the rock properties comprises the following. The receiver wavefield is back-propagated, and a cross-correlation imaging condition is applied to obtain source images of the sources without using a picking process. A location of each source is selected, where the location is associated with maximum energy in the source image. A source signature is estimated by extracting the back-propagated receiver wavefields at the source location. A conventional seismic migration method is applied to obtain a subsurface image under each source. The source wavefield is forward-propagated using the estimated source signature. The receiver wavefield is back-propagated. A zero-lag cross-correlation imaging condition is applied to cross-correlate the source wavefield and the receiver wavefield to obtain the subsurface image ahead of the drill bit. The subsurface image ahead of the drill bit is used to navigate drilling.

In a second implementation, a non-transitory, computer-readable medium storing one or more instructions executable by a computer system to perform operations comprising the following. A field dataset of seismic waves is received that is obtained by receivers during a drilling period from a drilling operation at a target well. The drilling period includes drilling phases and non-drilling phases. The field dataset is analyzed to determine locations of seismic waves. A reconstructed wavefield is determined by applying a passive seismic imaging condition over time based on locations of the receivers. Using the reconstructed wavefield, a time series is computed for the seismic waves, and a time-frequency transform is applied on the time series. Sources and locations of tube waves resulting from acoustic signatures of the drill bit and the drilling phases are determined from acoustic signatures of the drill bit the drilling phases. Sources and locations of the body waves caused by the tube waves are determined from the reconstructed wavefield. A petrophysical model of the target well is updated in real-time based on the analyzing and the sources and locations of the body waves and the tube waves, where real-time is a specified period of time.

The foregoing and other described implementations can each, optionally, include one or more of the following features:

A first feature, combinable with any of the following features, the operations further comprising updating seismic logging information in real-time during the drilling operation using the updated petrophysical model.

A second feature, combinable with any of the previous or following features, the operations further comprising predicting, in real-time and using the updated petrophysical model, geophysical formations ahead of drill bit.

A third feature, combinable with any of the previous or following features, the operations further comprising performing preprocessing on the field dataset including: processing the field dataset, the processing including pilot trace correlation, band-pass filtering, bad traces muting, and amplitude correction; and updating the field dataset based on the processing.

A fourth feature, combinable with any of the previous or following features, wherein the receivers include a geophone array of individual geophones arranged at pre-determined intervals, and wherein a center of the geophone array is located a distance away from a surface location of the target well.

A fifth feature, combinable with any of the previous or following features, wherein updating the seismic logging information during the drilling operation comprises the following. A moveout correction to traces in the seismic logging information is applied by applying a source-receiver distance dependent time shift to each trace of the seismic logging information. The traces are combined into a single trace by summing amplitude values of all traces at each time step and normalizing the traces to create a supertrace. A time-frequency analysis method is applied to the supertrace, decomposing the time series within each short-time window into different frequency components. Rock properties around and ahead of the drill bit are predicted using the time-frequency analysis and by applying machine learning techniques. The rock properties are associated with geological formations, including rock hardness, pore pressure, and fractures. A drilling program is adjusted in real time using the predicted rock properties around and ahead of the drill bit.

A sixth feature, wherein predicting the rock properties comprises the following. The receiver wavefield is back-propagated, and a cross-correlation imaging condition is applied to obtain source images of the sources without using a picking process. A location of each source is selected, where the location is associated with maximum energy in the source image. A source signature is estimated by extracting the back-propagated receiver wavefields at the source location. A conventional seismic migration method is applied to obtain a subsurface image under each source. The source wavefield is forward-propagated using the estimated source signature. The receiver wavefield is back-propagated. A zero-lag cross-correlation imaging condition is applied to cross-correlate the source wavefield and the receiver wavefield to obtain the subsurface image ahead of the drill bit. The subsurface image ahead of the drill bit is used to navigate drilling.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light-emitting diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with some implementations of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

Cluster file system involved in this invention can be any file system type accessible from multiple servers for read and update. Locking or consistency tracking is not necessary in this invention since the locking of exchange file system can be done at application layer. Furthermore, Unicode data files are different from non-Unicode data files.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving a field dataset of seismic waves obtained by receivers during a drilling period from a drilling operation at a target well, wherein the drilling period includes drilling phases and non-drilling phases;
analyzing the field dataset to determine locations of seismic waves, including:
determining a reconstructed wavefield by applying a passive seismic imaging condition over time and based on locations of the receivers;
computing, using the reconstructed wavefield, a time series for the seismic waves and applying a time-frequency transform on the time series;
determining, from the time-frequency transform, sources and locations of tube waves resulting from acoustic signatures of the drill bit the drilling phases; and
determining, from the reconstructed wavefield, sources and locations of the body waves caused by the tube waves; and
updating, in real-time based on the analyzing and the sources and locations of the body waves and the tube waves, a petrophysical model of the target well, wherein real-time is a specified period of time.

2. The computer-implemented method of claim 1, further comprising updating, in real-time and using the updated petrophysical model, seismic logging information during the drilling operation.

3. The computer-implemented method of claim 1, further comprising predicting, in real-time and using the updated petrophysical model, geophysical formations ahead of drill bit.

4. The computer-implemented method of claim 1, further comprising performing preprocessing on the field dataset including:
processing the field dataset, the processing including pilot trace correlation, band-pass filtering, bad traces muting, and amplitude correction; and
updating the field dataset based on the processing.

5. The computer-implemented method of claim 1, wherein the receivers include a geophone array of individual geophones arranged at pre-determined intervals, and wherein a center of the geophone array is located a distance away from a surface location of the target well.

6. The computer-implemented method of claim 2, wherein updating the seismic logging information during the drilling operation comprises:
applying a moveout correction to traces in the seismic logging information by applying a source-receiver distance dependent time shift to each trace of the seismic logging information;
combining the traces into a single trace by summing amplitude values of all traces at each time step and normalizing the traces to create a supertrace;
applying a time-frequency analysis method to the supertrace, decomposing the time series within each short-time window into different frequency components;
predicting, using the time-frequency analysis and by applying machine learning techniques, rock properties around and ahead of the drill bit, the rock properties associated with geological formations, including rock hardness, pore pressure, and fractures; and
using the predicted rock properties around and ahead of the drill bit to adjust a drilling program in real time.

7. The computer-implemented method of claim 3, wherein predicting the rock properties comprises:
back-propagating the receiver wavefield and applying a cross-correlation imaging condition to obtain source images of the sources without using a picking process;
selecting a location of each source, the location associated with maximum energy in the source image;
estimating a source signature by extracting the back-propagated receiver wavefields at the source location;
applying a conventional seismic migration method to obtain a subsurface image under each source, including:
forward-propagating the source wavefield using the estimated source signature;
back-propagating the receiver wavefield; and
applying a zero-lag cross-correlation imaging condition to cross-correlate the source wavefield and the receiver wavefield to obtain the subsurface image ahead of the drill bit; and
using the subsurface image ahead of the drill bit to navigate drilling.

8. A non-transitory, computer-readable medium storing one or more instructions executable by a computer system to perform operations comprising:
receiving a field dataset of seismic waves obtained by receivers during a drilling period from a drilling operation at a target well, wherein the drilling period includes drilling phases and non-drilling phases;
analyzing the field dataset to determine locations of seismic waves, including:
determining a reconstructed wavefield by applying a passive seismic imaging condition over time and based on locations of the receivers;
computing, using the reconstructed wavefield, a time series for the seismic waves and applying a time-frequency transform on the time series;
determining, from the time-frequency transform, sources and locations of tube waves resulting from acoustic signatures of the drill bit the drilling phases; and
determining, from the reconstructed wavefield, sources and locations of the body waves caused by the tube waves; and
updating, in real-time based on the analyzing and the sources and locations of the body waves and the tube waves, a petrophysical model of the target well, wherein real-time is a specified period of time.

9. The non-transitory, computer-readable medium of claim 8, the operations further comprising updating, in real-time and using the updated petrophysical model, seismic logging information during the drilling operation.

10. The non-transitory, computer-readable medium of claim 8, the operations further comprising predicting, in real-time and using the updated petrophysical model, geophysical formations ahead of drill bit.

11. The non-transitory, computer-readable medium of claim 8, the operations further comprising performing preprocessing on the field dataset including:
processing the field dataset, the processing including pilot trace correlation, band-pass filtering, bad traces muting, and amplitude correction; and
updating the field dataset based on the processing.

12. The non-transitory, computer-readable medium of claim 8, wherein the receivers include a geophone array of individual geophones arranged at pre-determined intervals, and wherein a center of the geophone array is located a distance away from a surface location of the target well.

13. The non-transitory, computer-readable medium of claim 9, wherein updating the seismic logging information during the drilling operation comprises:
applying a moveout correction to traces in the seismic logging information by applying a source-receiver distance dependent time shift to each trace of the seismic logging information;
combining the traces into a single trace by summing amplitude values of all traces at each time step and normalizing the traces to create a supertrace;
applying a time-frequency analysis method to the supertrace, decomposing the time series within each short-time window into different frequency components;
predicting, using the time-frequency analysis and by applying machine learning techniques, rock properties around and ahead of the drill bit, the rock properties associated with geological formations, including rock hardness, pore pressure, and fractures; and
using the predicted rock properties around and ahead of the drill bit to adjust a drilling program in real time.

14. The non-transitory, computer-readable medium of claim 10, wherein predicting the rock properties comprises:
back-propagating the receiver wavefield and applying a cross-correlation imaging condition to obtain source images of the sources without using a picking process;
selecting a location of each source, the location associated with maximum energy in the source image;
estimating a source signature by extracting the back-propagated receiver wavefields at the source location;
applying a conventional seismic migration method to obtain a subsurface image under each source, including:
forward-propagating the source wavefield using the estimated source signature;
back-propagating the receiver wavefield; and
applying a zero-lag cross-correlation imaging condition to cross-correlate the source wavefield and the receiver wavefield to obtain the subsurface image ahead of the drill bit; and
using the subsurface image ahead of the drill bit to navigate drilling.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving a field dataset of seismic waves obtained by receivers during a drilling period from a drilling operation at a target well, wherein the drilling period includes drilling phases and non-drilling phases;
analyzing the field dataset to determine locations of seismic waves, including:
determining a reconstructed wavefield by applying a passive seismic imaging condition over time and based on locations of the receivers;
computing, using the reconstructed wavefield, a time series for the seismic waves and applying a time-frequency transform on the time series;
determining, from the time-frequency transform, sources and locations of tube waves resulting from acoustic signatures of the drill bit the drilling phases; and
determining, from the reconstructed wavefield, sources and locations of the body waves caused by the tube waves; and
updating, in real-time based on the analyzing and the sources and locations of the body waves and the tube waves, a petrophysical model of the target well, wherein real-time is a specified period of time.

16. The computer-implemented system of claim 15, the operations further comprising updating, in real-time and using the updated petrophysical model, seismic logging information during the drilling operation.

17. The computer-implemented system of claim 15, the operations further comprising predicting, in real-time and using the updated petrophysical model, geophysical formations ahead of drill bit.

18. The computer-implemented system of claim 15, the operations further comprising performing preprocessing on the field dataset including:
processing the field dataset, the processing including pilot trace correlation, band-pass filtering, bad traces muting, and amplitude correction; and
updating the field dataset based on the processing.

19. The computer-implemented system of claim 15, wherein the receivers include a geophone array of individual geophones arranged at pre-determined intervals, and wherein a center of the geophone array is located a distance away from a surface location of the target well.

20. The computer-implemented system of claim 16, wherein updating the seismic logging information during the drilling operation comprises:
applying a moveout correction to traces in the seismic logging information by applying a source-receiver distance dependent time shift to each trace of the seismic logging information;
combining the traces into a single trace by summing amplitude values of all traces at each time step and normalizing the traces to create a supertrace;
applying a time-frequency analysis method to the supertrace, decomposing the time series within each short-time window into different frequency components;
predicting, using the time-frequency analysis and by applying machine learning techniques, rock properties around and ahead of the drill bit, the rock properties associated with geological formations, including rock hardness, pore pressure, and fractures; and
using the predicted rock properties around and ahead of the drill bit to adjust a drilling program in real time.
